(19) United States
(12) Patent Application Publication
(10) Pub. No.: US 2008/0080715 A1
(43) Pub. Date: Apr. 3, 2008

(54) APPARATUS AND METHOD FOR HIGH-SPEED, LARGE-VOLUME DATA ENCRYPTION USING SECURE MEMORY

(76) Inventors: Ho Gyun Lee, Daejeon-city (KR); Jintae Oh, Daejeon-city (KR); Taek Yong Nam, Daejeon-city (KR); Seungmin Lee, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/863,394

(22) Filed: Sep. 28, 2007

(30) Foreign Application Priority Data
Sep. 29, 2006 (KR) 10-2006-0096590

(51) Int. Cl. H04L 9/00; G06F 12/16

(52) U.S. Cl. 380/277; 713/190

(57) ABSTRACT

Provided are an apparatus and a method for data encryption using a secure memory, and more particularly, to an apparatus and a method for high-speed, large-volume data encryption using a security function included in the secure memory in response to an encryption/decryption request of a user application program. Conventional data encryption methods perform data encryption using software or hardware including a peripheral component interconnect (PCI) bus. However, the conventional data encryption methods do not satisfy speed-sensitive applications. To improve this problem, the present invention provides an apparatus and a method for high-speed, large-volume data encryption using a security function of a memory.

### CROSS-REFERENCE TO RELATED PATENT APPLICATION

This application claims the benefit of Korean Patent Application No. 10-2006-0096590, filed on Sep. 29, 2006, in the Korean Intellectual Property Office, the disclosure of which is incorporated herein in its entirety by reference.

### BACKGROUND OF THE INVENTION

1. Field of the Invention

The present invention relates to an apparatus and a method for data encryption using a secure memory, and more particularly, to an apparatus and a method for high-speed, large-volume data encryption using a security function included in the secure memory in response to an encryption/decryption request of a user application program.

This work was party supported by the IT R&D program of MIC/IITA [2005-S-402-02, The Development of the High Performance Network Security System]

2. Description of the Related Art

As network security and data security has come into the spotlight, the demand for high-speed, large-volume data encryption technology is increasing. In particular, in a database security field, a variety of methods of high-speed data encryption are being researched in order to provide column unit encryption without performance deterioration of a large-volume database. Currently, a method of encrypting data by connecting two different systems to a network with a security hardware device out of a database system, and a method of performing data encryption by software in the database system are being developed. However, both methods can not satisfy the demand of a database security market and the technology has to be improved as soon as possible.

That is, conventional data encryption methods generally use software or hardware to which a peripheral component interconnect (PCI) bus is connected. However, the conventional data encryption methods do not satisfy speed-sensitive applications. Each of the two methods is described in detail below.

First, the method using software consumes central processing unit (CPU) resources of the corresponding system, and high-speed, large-volume data encryption can not be performed due to a bottleneck of a PCI bus. In the method using hardware, a time-delay can be incurred when different hardware devices communicate with each other using PCI, and overload of a certain processor such as a CPU can also be caused. To improve the above problems, the present invention provides an apparatus and a method for high-speed, large-volume data encryption using a security function of a memory. However, a few conventional inventions disclose a memory area divided into a secure area and a non-secure area.

United States Patent Publication Number 20030133574 entitled ‘Secure CPU and Memory Management Unit with Cryptographic Extensions’ filed on Jan. 16, 2002 by Sun Microsystems, Inc. discloses a memory area divided into a secure area and a non-secure area. However, the cited invention performs data encryption using a CPU, a memory management unit, and an encryption/decryption unit such that CPU resources are consumed and speed deterioration can occur due to a bottleneck of a PCI bus being used. The cited invention only emphasizes that a secure area is provided. However, a method of high-speed encryption is not described in the cited invention.

United States Patent Publication Number 20060015749 entitled ‘Method and Apparatus for Secure Execution Using a Secure Memory Partition’ filed on Sep. 20, 2005 by Mr. Millind Mittal discloses a similar method of data encryption. In the cited invention, the CPU is also concerned with data encryption such that CPU overload occurs, and speed deterioration also occurs due to a bottleneck of a PCI being used.

### SUMMARY OF THE INVENTION

The present invention provides an apparatus and a method for data encryption using a secure random-access memory (RAM) including an embedded secure part which performs data encryption at the same speed as the data transfer speed of the memory.

The present invention also provides a method of data encryption/decryption using the secure RAM in response to an encryption/decryption request of a user application program.

According to an aspect of the present invention, there is provided an apparatus for data encryption using a memory having a security function, the apparatus including a normal memory storing data which is requested to be encrypted by a user application program; and a secure memory disposed in the same input/output standard memory slot as the normal memory, wherein the secure memory memory-copies the data at a data copying speed between two normal memories, independently performs an encryption operation and/or an encryption key management operation using an embedded secure part, and memory-copies the data that has been operated on to the normal memory.

According to another aspect of the present invention, there is provided an apparatus for processing an encryption/decryption request of a user application program, the apparatus including an encryption request receiver which receives a data encryption/decryption request from the user application program and verifies that the encryption/decryption requested data is stored in a normal memory; a secure memory checker which checks whether a secure memory having a security function is enabled by checking currently available address space and/or a scheduled encryption order of the secure memory for the process of the verified data; an encryption-requested data copier which copies the encryption/decryption-requested data stored in the normal memory to the secure memory, if the secure memory is enabled; an encrypter which encrypts or decrypts the copied data based on an encryption/decryption key allocated by the cryptographic key management policy using a security function of the secure memory; and an encrypted data provider which provides the encrypted/decrypted data to the user application program by copying the data to the normal memory.

According to another aspect of the present invention, there is provided a method of data encryption using a memory having a security function, the method including memory-copying encryption/decryption-requested data from a normal memory to a secure memory having a security function and using the same input/output standard as the normal memory according to a request of a user application program; performing encryption/decryption of the copied data based on an encryption/decryption key allocated by the cryptographic key management policy using the security function of the secure memory; and memory-copying the encrypted or decrypted data to the normal memory.

According to another aspect of the present invention, there is provided a method of processing a data encryption/decryption request of a user application program using a memory having a security function, the method including receiving the data encryption/decryption request from the user application program and verifying that the encryption/decryption requested data is stored in a normal memory; checking whether a secure memory having a security function is enabled by checking currently available address space and/or scheduled encryption order of the secure memory for the process of the verified data; copying the encryption/decryption-requested data stored in the normal memory to the secure memory, if the secure memory is enabled; performing encryption or decryption of the copied data based on an encryption/decryption key allocated by the cryptographic key management policy using the security function of the secure memory; and providing the encrypted/decrypted data to the user application program by copying the data to the normal memory.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the configuration of an apparatus for data encryption using a secure memory according to an embodiment of the present invention;

FIG. 2 illustrates the product configuration of a secure memory according to an embodiment of the present invention;

FIG. 3 illustrates the internal configuration of a secure memory according to an embodiment of the present invention;

FIG. 4 illustrates the configuration of an apparatus for processing an encryption/decryption request of a user application program according to an embodiment of the present invention;

FIG. 5 is a flowchart of a method of data encryption/decryption using a secure memory according to an embodiment of the present invention;

FIG. 6 is a flowchart of a method of processing an encryption/decryption request of a user application program according to an embodiment of the present invention;

FIG. 7 illustrates a flow of encryption-related messages among a user, a system and a secure memory according to an embodiment of the present invention;

FIG. 8 illustrates an encryption/decryption process of data among a user, a system and a secure memory according to an embodiment of the present invention; and

FIG. 9 illustrates a process of copying data between normal memory and a secure memory according to an embodiment of the present invention.

### DETAILED DESCRIPTION OF THE INVENTION

Hereinafter, the present invention will be described in detail by explaining embodiments of the invention with reference to the attached drawings.

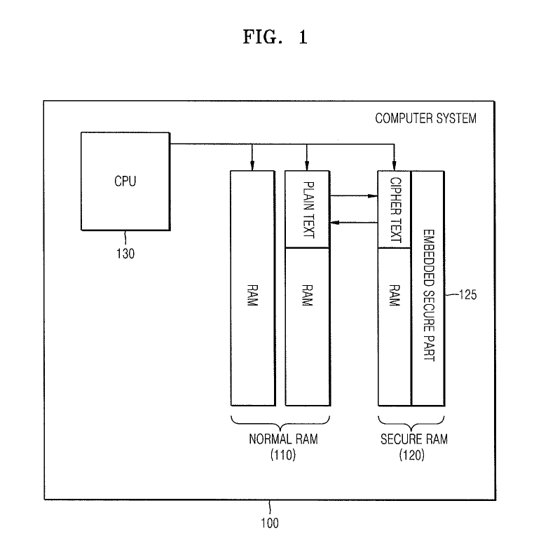

FIG. 1 illustrates the configuration of an apparatus for data encryption using a secure RAM 120 according to an embodiment of the present invention.

Conventional secure systems operate at low speed due to a bus bottleneck that occurs during data transfer and a calculation load that occurs during a data encryption process. To solve the bus bottleneck, the data encryption can be performed in random-access memory (RAM). To solve the calculation load, an embedded encryption chip can be included in the RAM for performing data encryption.

Since conventional secure systems use CPU sources for data encryption, performance deterioration of the systems occurs. Unlike the conventional computer configuration in which a CPU performs only operation processes and the RAM performs only data storage and data conversion, the present invention provides an apparatus and a method for high-speed, large-volume data encryption by adding a secure function to the RAM. The present invention also provides a method of applying encryption RAM (hereinafter referred to as secure RAM) to conventional systems and a method of developing software for the encryption RAM.

The configuration of a high-speed encryption system using the secure RAM 120 is illustrated in FIG. 1. The system is constituted by including the secure RAM 120 in a normal computer system 100. The secure RAM 120 is mounted in the computer system 100 using the same slot as a conventional normal RAM 110 and performs the same basic operations as the normal RAM 110. However, the difference between the normal RAM 110 and the secure RAM 120 is that an embedded secure part 125 is included in the secure RAM 120 such that data encryption can be performed without CPU load.

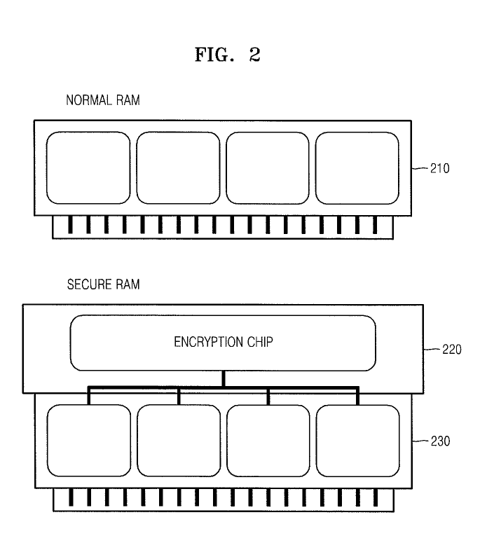

FIG. 2 illustrates the product configuration of a secure RAM according to an embodiment of the present invention.

Referring to FIG. 2, the secure RAM uses a standard input/output (I/O) RAM 230 the same as a normal RAM 210 and includes an encryption chip 220 by expanding the upper part of the I/O standard RAM 230. As a result, the secure RAM can copy data at memory copy speed when copying data to or from the normal RAM 210.

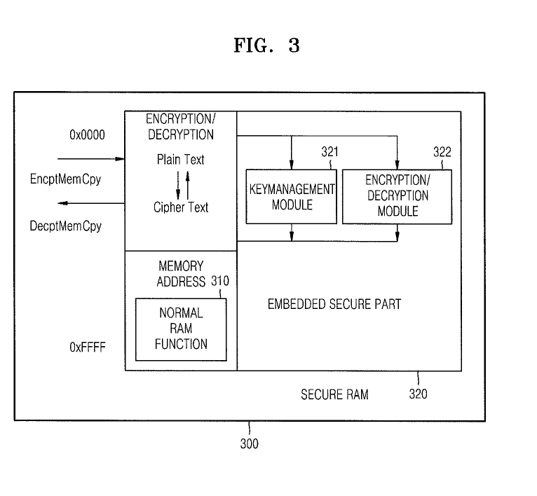

FIG. 3 illustrates the internal configuration of a secure RAM 300 according to an embodiment of the present invention.

FIG. 3 is a block diagram of the internal configuration of the secure RAM 300. Mainly, the secure RAM 300 is divided into a normal RAM function part 310 and an embedded secure part 320. Communication with a CPU is performed through a conventional data bus and a conventional control bus using the normal RAM function part 310. The embedded secure part 320 is divided into a key management module 321 and an encryption/decryption module 322. The key management module 321 performs management of an encryption/decryption key according to a cryptographic key management policy and the encryption/decryption module 322 is concerned with data encryption/decryption.

A system to which the secure RAM is applied has to include both normal RAM and secure RAM. If data in a certain area of the normal RAM has to be encrypted, the data is memory copied to the secure RAM area. When the data is copied to the secure RAM, data encryption is automatically performed. The encrypted data is transferred to the normal RAM area by performing memory copy once again. This process is performed by a cryptographic application programming interface (CAPI) of a library to be provided.

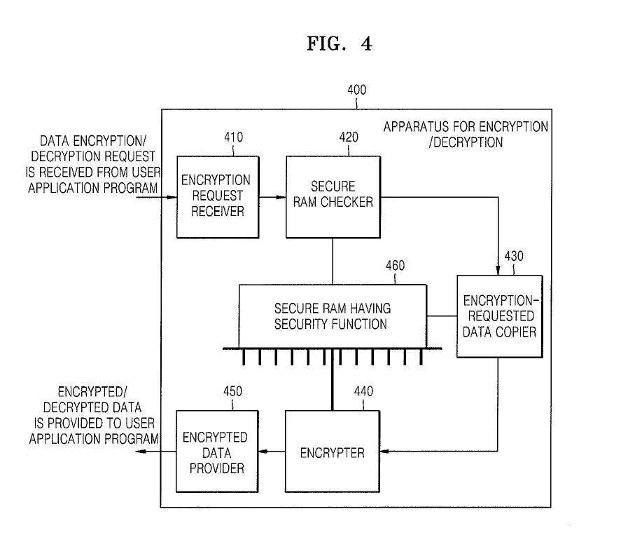

FIG. 4 illustrates the configuration of an apparatus 400 for processing an encryption/decryption request of a user application program according to an embodiment of the present invention.

FIG. 4 is a block diagram illustrating a process of the apparatus 400. First, an encryption request receiver 410 receives a data encryption/decryption request from a user application program and verifies that the encryption/decryption-requested data is stored in a normal RAM. A secure RAM checker 420 checks whether secure RAM 460 having a security function is enabled according to a currently available address space and/or a scheduled encryption order of the secure RAM 460.

Then, if the secure RAM 460 is enabled, an encryption requested data copier 430 copies the encryption/decryption-requested data stored in the normal RAM to the secure RAM 460. An encrypter 440 encrypts or decrypts the copied data based on an encryption/decryption key according to cryptographic key management policy using a security function of the secure RAM 460.

Lastly, an encrypted data provider 450 provides the encrypted/decrypted data to the user application program by copying the data to the normal RAM.

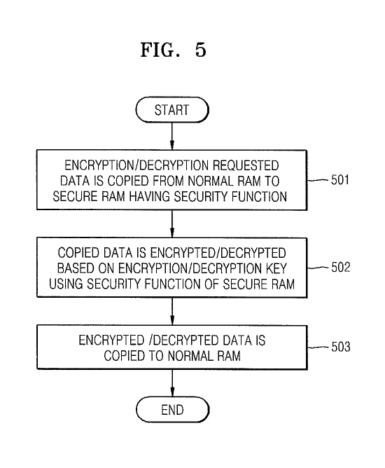

FIG. 5 is a flowchart of a method of data encryption/decryption using a secure RAM according to an embodiment of the present invention.

FIG. 5 illustrates processes of copying data and encrypting data in the secure RAM and normal RAM. In response to a request of a user application program, encryption/decryption-requested data is copied using the same I/O standard as the normal RAM from the normal RAM to the secure RAM having a security function (operation 501). The copied data is encrypted or decrypted based on an encryption/decryption key allocated by the cryptographic key management policy using the security function of the secure RAM (operation 502). Then, data encryption is completed by memory-copying the encrypted or decrypted data to the normal RAM (operation 503).

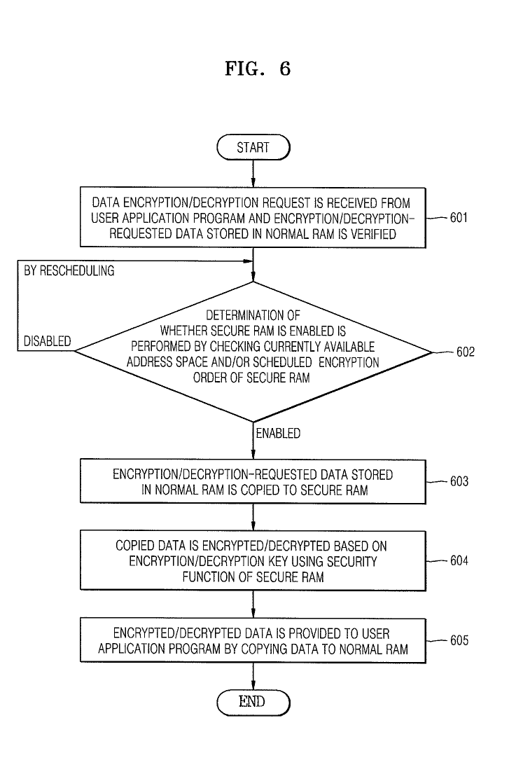

FIG. 6 is a flowchart of a method of processing an encryption/decryption request of a user application program according to an embodiment of the present invention.

FIG. 6 illustrates the processes of an encryption request and an encryption procedure in a whole system including a user application program, a normal RAM and a secure RAM.

First, a data encryption/decryption request is received from the user application program and the encryption/decryption-requested data stored in the normal RAM is verified (operation 601). Determination of whether the secure RAM having a security function is enabled is performed by checking a currently available address space and/or a scheduled encryption order of the secure RAM in order to process the verified data (operation 602). If the secure RAM is disabled, the process is paused until the secure RAM is enabled by appropriate measures such as rescheduling. If the secure RAM is enabled, the encryption/decryption-requested data stored in the normal RAM is copied to the secure RAM (operation 603). Encryption or decryption of the copied data is performed based on an encryption/decryption key allocated by the cryptographic key management policy using the security function of the secure RAM (operation 604). The encrypted/decrypted data is provided to the user application program by copying the data to the normal RAM (operation 605).

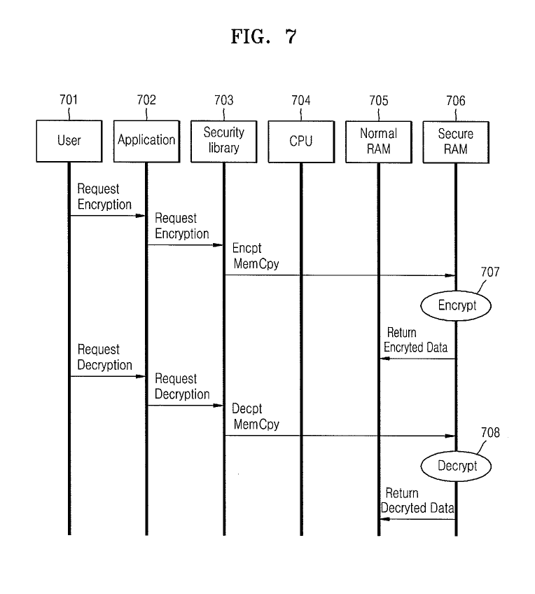

FIG. 7 illustrates the flow of encryption-related messages among a user, a system and secure RAM according to an embodiment of the present invention.

Features of main elements in the drawing will now be described below.

A secure RAM 706 is included in a computer system using the same slot as a normal RAM 705 and communicates with a CPU 704 using the same bus I/O standard as the normal RAM 705. An embedded encryption chip is additionally included in the secure RAM 706 such that self data encryption and self key management can be performed. When arbitrary data is copied to the secure RAM 706, the embedded encryption chip automatically encrypts the data and returns the encrypted data to an address space of the normal RAM 705 which has requested data encryption.

A security library 703 has software application program interfaces (APIs) which can control the secure RAM 706. A user 701 can perform high-speed data encryption using the secure RAM 706 of his/her program by calling the APIs. Furthermore, the security library 703 can control encryption chip scheduling, address space reallocation, and encryption requesting.

Under the above-described configuration, when the user 701 requests encryption of data, an application program 702 requests encryption of the corresponding address area by calling APIs of the security library 703. The security library 703 copies data of the address space of the normal RAM 705 to the secure RAM 706. When new data is copied, the secure RAM 706 automatically encrypts 707 the corresponding address space. The encrypted data is automatically returned to the normal RAM area 705. Decryption 708 is performed using the same process. These encryption processes do not require the CPU 704 to perform operations and data copy out of memory is not performed such that a delay due to a bus bottleneck does not occur.

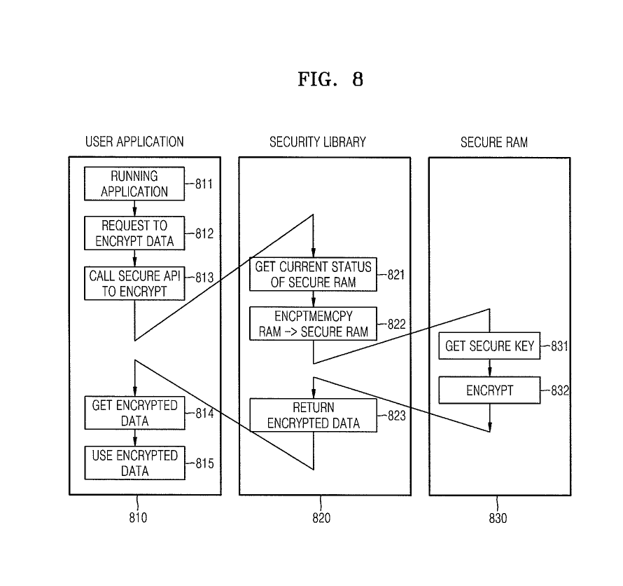

FIG. 8 illustrates an encryption/decryption process of data among a user, a system and secure RAM according to an embodiment of the present invention.

FIG. 8 shows internal operations of main elements of FIG. 7 for data encryption.

While a user application program 810 is running (operation 811), the user application program 810 calls APIs of a security library 820 (operation 813) to request data encryption (operation 812). When the APIs are called, the security library 820 checks a current status of the secure RAM 830 first (operation 821). Since data encryption can be requested from a plurality of application programs simultaneously, encryption order of address space of the secure RAM 830 and an encryption chip is scheduled. Lastly, when the secure RAM 830 is enabled, data of normal RAM is copied to the secure RAM 830 (operation 822). When the new copied data is recognized, the secure RAM 830 allocates an encryption key according to the cryptographic key management policy (operation 831) and automatically encrypts the corresponding data (operation 832). Then, the encrypted data is returned to the normal RAM (operation 823), an address of the returned data is reset at the security library 820 and the data is returned to the user application program 810 (operation 814), and the user application program 810 uses the encrypted data (operation 815).

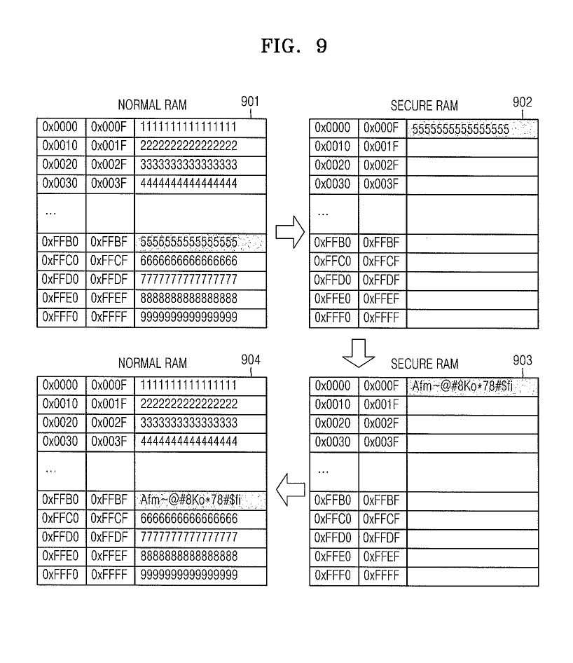

FIG. 9 illustrates a process of copying data between normal RAM and secure RAM according to an embodiment of the present invention.

Referring to FIG. 9, data “555555555555555” in address spaces 0xFFB0 through 0xFFBF of the normal RAM will now be encrypted (operation 901).

First, the data is copied to address spaces of the secure RAM using APIs of a security library according to the present invention (operation 902). When new data is copied to the secure RAM area, the secure RAM automatically encrypts the data (operation 903). The encrypted data is automatically returned to the normal RAM area (operation 904).

In the above-described process, the length of the original data and the length of the encrypted data can vary according to the applied encryption algorithm. That is, when 16-byte data “5555555555555555” is encrypted, new data with a different-length, i.e., not 16-byte data, can be generated. In this case, the normal RAM requires new address space for the new data with the different-length. In particular, it is required to reset an address value of the normal RAM from the new data based on the size of data to be changed by the encryption/decryption process before copying the data to the normal RAM. The address space preparation and the data copy can be performed by software in the library provided with the secure RAM.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

In a high-speed, large-volume data encryption system using a secure memory according to the present invention, performance improvement can be provided to conventional security systems having performance deterioration. Conventional security systems using software or hardware have low performance due to their dependence on CPU resources and the presence of a bus bottleneck. However, the data encryption system using the secure memory according to the present invention does not consume CPU resources. Furthermore, there is no bus bottleneck since data encryption is performed in the memory.

Demand for data security is expected to increase due to enforcement of personal information protection laws. An advantage of the present invention is that it can be applied to conventional systems regardless of application programs of the systems.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for data encryption using a memory having a security function, the apparatus comprising:
a normal memory storing data which is requested to be encrypted by a user application program; and
a secure memory disposed in the same input/output standard memory slot as the normal memory, wherein the secure memory memory-copies the data at a data copying speed between two normal memories, independently performs an encryption operation and/or an encryption key management operation using an embedded secure part, and memory-copies the data that has been operated on to the normal memory.

2. The apparatus for data encryption using the memory having a security function of claim 1, wherein the embedded secure part included in the secure memory is a separate chip in the secure memory and performs an encryption operation on the data based on an encryption key allocated by the cryptographic key management policy.

3. The apparatus for data encryption using the memory having a security function of claim 1, wherein the embedded secure part included in the secure memory performs a decryption operation on the encrypted data and/or a decryption key management operation.

4. An apparatus for processing an encryption/decryption request of a user application program, the apparatus comprising:
an encryption request receiver which receives a data encryption/decryption request from the user application program and verifies that the encryption/decryption requested data is stored in a normal memory;
a secure memory checker which checks whether a secure memory having a security function is enabled by checking currently available address space and/or a scheduled encryption order of the secure memory for the process of the verified data;
an encryption-requested data copier which copies the encryption/decryption-requested data stored in the normal memory to the secure memory, if the secure memory is enabled;
an encrypter which encrypts or decrypts the copied data based on an encryption/decryption key allocated by the cryptographic key management policy using a security function of the secure memory; and
an encrypted data provider which provides the encrypted/decrypted data to the user application program by copying the data to the normal memory.

5. A method of data encryption using a memory having a security function, the method comprising:
(a) memory-copying encryption/decryption-requested data from a normal memory to a secure memory having a security function and using the same input/output standard as the normal memory according to a request of a user application program;
(b) performing encryption/decryption of the copied data based on an encryption/decryption key allocated by the cryptographic key management policy using the security function of the secure memory; and
(c) memory-copying the encrypted or decrypted data to the normal memory.

6. A method of processing a data encryption/decryption request of a user application program using a memory having a security function, the method comprising:
(a) receiving the data encryption/decryption request from the user application program and verifying that the encryption/decryption requested data is stored in a normal memory;
(b) checking whether a secure memory having a security function is enabled by checking currently available address space and/or scheduled encryption order of the secure memory for the process of the verified data;
(c) copying the encryption/decryption-requested data stored in the normal memory to the secure memory, if the secure memory is enabled;
(d) performing encryption or decryption of the copied data based on an encryption/decryption key allocated by the cryptographic key management policy using the security function of the secure memory; and
(e) providing the encrypted/decrypted data to the user application program by copying the data to the normal memory.

7. The method of processing a data encryption/decryption request of a user application program using the memory having a security function of claim 6, wherein operation (e) comprises copying the encrypted/decrypted data to the normal memory after resetting an address value of the normal memory for the encrypted/decrypted data based on the size of the data changed by the encryption/decryption process.
